(19) United States
(12) Patent Application Publication
(10) Pub. No.: US 2025/0317524 A1
(43) Pub. Date: Oct. 9, 2025

(54) INFORMATION PROCESSING APPARATUS AND METHOD OF CONTROLLING INFORMATION PROCESSING APPARATUS

(71) Applicant: CANON KABUSHIKI KAISHA, Tokyo (JP)

(72) Inventor: NAOHIKO NOMURA, Kanagawa (JP)

(21) Appl. No.: 19/171,912

(22) Filed: Apr. 7, 2025

(30) Foreign Application Priority Data
Apr. 9, 2024 (JP) 2024-062611

(51) Int. Cl. H04N 1/23; H04N 1/00

(52) U.S. Cl. CPC H04N 1/2323; H04N 1/00015; H04N 1/00068; H04N 1/00087

(57) ABSTRACT

An information processing apparatus includes: an obtainment unit configured to obtain a characteristic value of a fed printing medium; a registration unit configured to register a type of the printing medium as an estimation target; an estimation unit configured to estimate a type of the fed printing medium by using an estimator from a plurality of types of the printing medium registered with the registration unit based on the characteristic value obtained by the obtainment unit; a change unit configured to change the type of the printing medium registered with the registration unit; and an output unit configured to output an instruction to update the estimator by using the characteristic value corresponding to the changed type of the printing medium.

### BACKGROUND

### Field of the Disclosure

The present disclosure relates to a technique of estimating a type of a printing medium.

### Description of the Related Art

In commercial and industrial printing markets, application of output products is various such as a CAD outline, a poster, an art piece, and a signage. Therefore, printing media of a variety of characteristics corresponding to the application have been used. As the types of the printing media are increased, a work of a user to select the type of the printing medium fed to the printing apparatus becomes cumbersome. As for a recent printing apparatus, a function that improves usability by automatically estimating a type of a fed printing medium has been mounted. However, since the estimation by the automatic estimation function is performed based on information of a printing medium determined in advance, it is impossible to estimate an unknown printing medium. Accordingly, it is desirable to make it possible to expand the types of the printing medium according to previous applications by a user.

Japanese Patent Laid-Open No. 2022-078426 (hereinafter, referred to as PTL 1) discloses a technique of estimating a type of a printing medium by using a learned model that learns in advance spectroscopic information of an unprinted region of the printing medium and an identifier indicating the type of the printing medium. In the PTL 1, in a case where the type of the printing medium is estimated as an unknown printing medium, the learning is performed again by using the spectroscopic information of the unknown printing medium and the identifier indicating the type of the printing medium to update the learned model, and thus the types of the printing medium that can be estimated are expanded.

In the update of the learning model by the relearning described in the PTL 1, there is an issue that, as the number of the types of the printing medium is increased, the learning model becomes complicated and the estimation accuracy is reduced. Additionally, since the amount of the learning data is also increased, there is an issue that the capacity of the learning model becomes great, which consumes a memory region in the apparatus.

### SUMMARY

An information processing apparatus according to embodiments of the present disclosure includes: an obtainment unit configured to obtain a characteristic value of a fed printing medium; a registration unit configured to register a type of the printing medium as an estimation target; an estimation unit configured to estimate a type of the fed printing medium by using an estimator from a plurality of types of the printing medium registered with the registration unit based on the characteristic value obtained by the obtainment unit; a change unit configured to change the type of the printing medium registered with the registration unit; and an output unit configured to output an instruction to update the estimator by using the characteristic value corresponding to the changed type of the printing medium.

Further features of the present disclosure will become apparent from the following description of exemplary embodiments with reference to the attached drawings.

### BRIEF DESCRIPTION OF THE DRAWINGS

FIG. 1 is a perspective view illustrating an example of a printing apparatus.

FIG. 2 is a cross-sectional view illustrating an example of a major portion of the printing apparatus.

FIG. 3 is a block diagram illustrating an example of a configuration of a control system of the printing apparatus.

FIG. 4 is a cross-sectional view illustrating an example of the vicinity of a media sensor.

FIG. 5 is a flowchart illustrating an example of processing of estimating a sheet type.

FIGS. 6A to 6D are diagrams each illustrating an example of a characteristic of a sheet.

FIG. 7 is a diagram illustrating an example of an estimation table of a sheet type.

FIG. 8 is a schematic diagram of a DNN.

FIG. 9 is a list tabulating an application, a category, and a type of a printing medium.

FIG. 10 is a flowchart illustrating an example of processing of manual selection.

FIG. 11 is a screen example of a case where application selection is performed in the manual selection.

FIG. 12 is a screen example of a case where category selection is performed in the manual selection.

FIG. 13 is a diagram illustrating an example of displaying a list in a usage history order in a case where individual selection is performed in the manual selection.

FIG. 14 is a diagram illustrating an example of displaying a list in the usage history order in a case where the individual selection is performed in the manual selection.

FIG. 15 is a flowchart illustrating an example of an operation of first processing of automatic selection.

FIG. 16 is a flowchart illustrating an example of an operation of second processing of the automatic selection.

FIGS. 17A and 17B are diagrams each illustrating an example of processing of updating a learned model.

### DESCRIPTION OF THE EMBODIMENTS

Preferred embodiments of the present disclosure are described below in detail with reference to the appended drawings. Note that, the following embodiments are not intended to limit the matters of the present disclosure, and not all the combinations of the characteristics described in the following embodiments are necessarily required for the means for solving the problems. Note that, the same reference numerals are provided to the same constituents. Additionally, relative arrangement, shapes, and the like of the constituents described in the embodiments are merely an example and are not intended to limit the scope of this disclose thereto.

Note that, in the descriptions of the following embodiments, “printing” includes not only a case of forming significant information such as a character and a graphic but also widely includes a case of forming an image, a design, a pattern, and the like on a sheet. Additionally, although a roll sheet is assumed as the sheet in the present embodiment, cut paper, cloth, a plastic film, or the like may be applied. In addition, “ink” should be construed widely and represents a liquid that can be provided for formation of the image, the design, the pattern, and the like or processing of the sheet or processing of an ink by being applied onto the sheet.

### First Embodiment

### <Ink Jet Printing Apparatus>

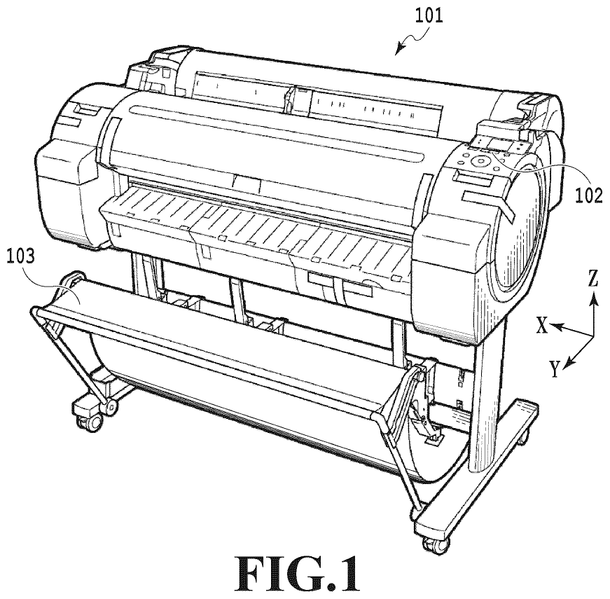

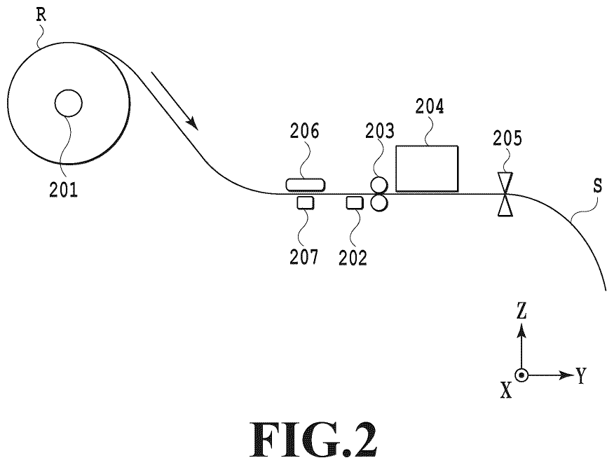

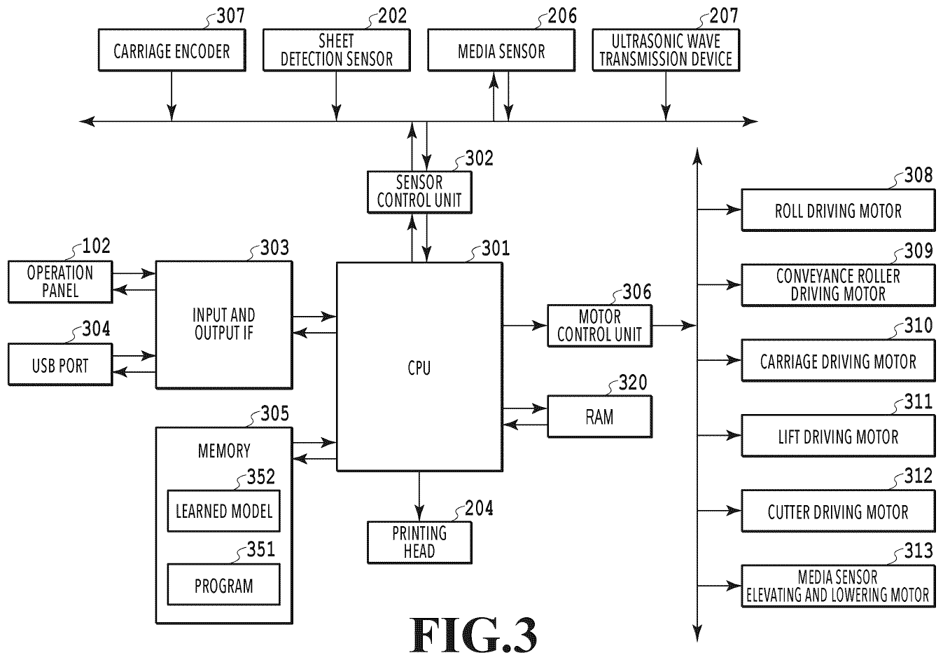

FIG. 1 is a perspective view illustrating an ink jet printing apparatus described as an example of a printing apparatus 101 that executes industrial and commercial printing in the present embodiment. FIG. 2 is a cross-sectional view illustrating an example of a major portion of the printing apparatus 101. FIG. 3 is a block diagram illustrating an example of a control configuration of the printing apparatus 101. Hereinafter, a configuration of the printing apparatus 101 is described with reference to FIGS. 1 to 3.

Note that, in the present embodiment, as described later, processing using a learned model is performed. In the present embodiment, descriptions are given assuming that the processing using the learned model is performed by the printing apparatus 101. That is, the printing apparatus 101 is an information processing apparatus using the learned model. Note that, the information processing apparatus using the learned model is not limited to the printing apparatus 101. A server (for example, a cloud server) that can transmit and receive various data to and from the printing apparatus 101 may be used as the information processing apparatus using the learned model.

Hereinafter, a conveyance direction in which a sheet S is conveyed in the printing apparatus 101 is a +Y direction. A direction in which a printing head 204 ejects an ink onto the sheet S is a −Z direction. A direction in which the printing head 204 moves from a standby position is a +X direction.

The printing apparatus 101 rotatably holds a roll sheet R around which the sheet S is wound in the form of a roll. The sheet S is supplied from the roll sheet R to a conveyance roller 203 with a roll driving motor 308 rotating the roll sheet R. The conveyance roller 203 can rotate the sheet S while pinching. The sheet S is conveyed to a position in which the printing head 204 can perform printing on the sheet S by rotating the conveyance roller 203 by a conveyance roller driving motor 309. The printing head 204 is mounted on a not-illustrated carriage and formed to reciprocally move in an X direction. An image is printed on the sheet S by ejecting the ink onto the conveyed sheet S from the printing head 204 while moving the printing head 204 in the X direction. The sheet S on which the image is printed is discharged from a discharge unit positioned downstream of the printing head 204 in the conveyance direction and is stacked on a basket 103.

An operation panel 102 is an interface module that receives various operations from a user. The user can perform various types of setting of the printing apparatus 101 by using various switches or touch panels included in the operation panel 102. The various types of setting of the printing apparatus 101 are, for example, setting of a size, a type, and the like of the sheet S. Additionally, the operation panel 102 displays an estimation result and the like described later.

In the conveyance direction, a sheet detection sensor 202 is arranged upstream of the conveyance roller 203. Once the sheet detection sensor 202 detects that the sheet S is supplied by the user from the roll sheet R, a conveyance operation of the sheet S is started. The conveyance operation of the sheet S is executed by driving the roll driving motor 308 and the conveyance roller driving motor 309 synchronously. In this process, the printing apparatus 101 can estimate the type of the sheet S by estimation of a sheet type that is described later. Details are described later.

In the conveyance direction, a media sensor 206 and an ultrasonic wave transmission device 207 are arranged upstream of the sheet detection sensor 202. The media sensor 206 is arranged above the sheet S in a direction of gravity (a Z direction), and the ultrasonic wave transmission device 207 is arranged below the sheet S in the direction of gravity. The media sensor 206 and the ultrasonic wave transmission device 207 are used for the later-described estimation of the sheet type.

Printing of an image on the sheet S is performed as follows. First, the printing apparatus 101 executes the conveyance operation to convey the sheet S to a position facing the printing head 204. Next, an image of a region of the sheet S that is corresponding to the printing head 204 is printed by executing a printing operation to scan the printing head 204 in a cross direction crossing (orthogonal to) the conveyance direction of the sheet S while ejecting the ink. Next, after the sheet S is conveyed by a predetermined amount, the ink is ejected while scanning the printing head 204 in the cross direction. Thus, a desired image is printed on the sheet S by executing the conveyance operation of the sheet S and the printing operation of the image alternately. The sheet S on which the image is printed is sequentially conveyed downstream of the printing head 204 in the conveyance direction. The conveyed sheet S is cut by a cutter 205 included in the discharge unit. The cut sheet S is stacked on the basket 103.

FIG. 3 is a block diagram illustrating an example of a configuration of a control system in the printing apparatus 101. The printing apparatus 101 includes the operation panel 102, the printing head 204, a CPU 301, a sensor control unit 302, and an input and output interface (IF) 303. The printing apparatus 101 includes a USB port 304, a memory 305, a motor control unit 306, and a RAM 320. Additionally, the printing apparatus 101 includes the sheet detection sensor 202, the media sensor 206, the ultrasonic wave transmission device 207, and a carriage encoder 307. Moreover, the printing apparatus 101 includes the roll driving motor 308, the conveyance roller driving motor 309, a carriage driving motor 310, a lift driving motor 311, a cutter driving motor 312, and a media sensor elevating and lowering motor 313. The memory 305 includes a program 351 and a learned model 352. The learned model 352 includes a learned model of rough classification, a learned model of detailed classification 1, and a learned model of detailed classification 2, which are described later. In the present embodiment, in a case where predetermined data is inputted to the learned model 352, a predetermined estimation result is outputted from the learned model 352. That is, the learned model 352 is an estimation unit that performs estimation.

The motor control unit 306 controls each driving motor according to the program 351 stored in the memory 305. The roll driving motor 308 rotates a spool 201 to convey the sheet S from the roll sheet R in the conveyance direction. The conveyance roller driving motor 309 rotates the conveyance roller 203 to convey the sheet S to a position facing the printing head 204. An encoder that detects a rotation amount to detect a conveyance amount of the sheet S is provided to the conveyance roller driving motor 309. It is possible to detect the conveyance amount of the sheet S by measuring the rotation amount of the encoder. The carriage driving motor 310 can move a not-illustrated carriage and the printing head 204 mounted on the carriage by rotating a not-illustrated carriage belt. The lift driving motor 311 moves the carriage and the printing head 204 up and down. The cutter driving motor 312 drives the cutter. The media sensor elevating and lowering motor 313 elevates and lowers the media sensor 206.

Various types of setting information and the like by a user operation from the operation panel 102, or a PC connected to the USB port 304 or a not-illustrated LAN port are inputted to the CPU 301 via the input and output IF 303. The inputted information is saved in the memory 305. The CPU 301 can read out the information saved in the memory 305 as needed and can perform various types of processing on the information read out. That is, the CPU 301 includes a processing unit that executes the various types of processing.

The CPU 301 controls the carriage encoder 307, the sheet detection sensor 202, the media sensor 206, and the ultrasonic wave transmission device 207 via the sensor control unit 302 and obtains output data outputted from each unit. The CPU 301 executes various controls based on input from the carriage encoder 307, the sheet detection sensor 202, and the media sensor 206. The CPU 301 controls the carriage encoder 307, the sheet detection sensor 202, the media sensor 206, and the ultrasonic wave transmission device 207 via the sensor control unit 302 and obtains the information. Additionally, the CPU 301 executes various controls based on inputs from the carriage encoder 307, the sheet detection sensor 202, and the media sensor 206. The RAM 320 is used as a temporal work area.

In the present embodiment, processing of estimating the type of the sheet by using the learned model of machine learning is described.

### <Estimation of Sheet Type>

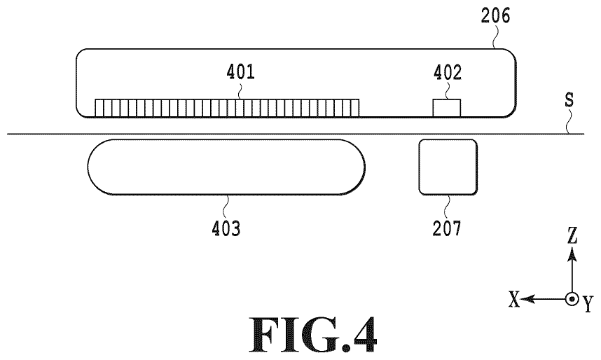

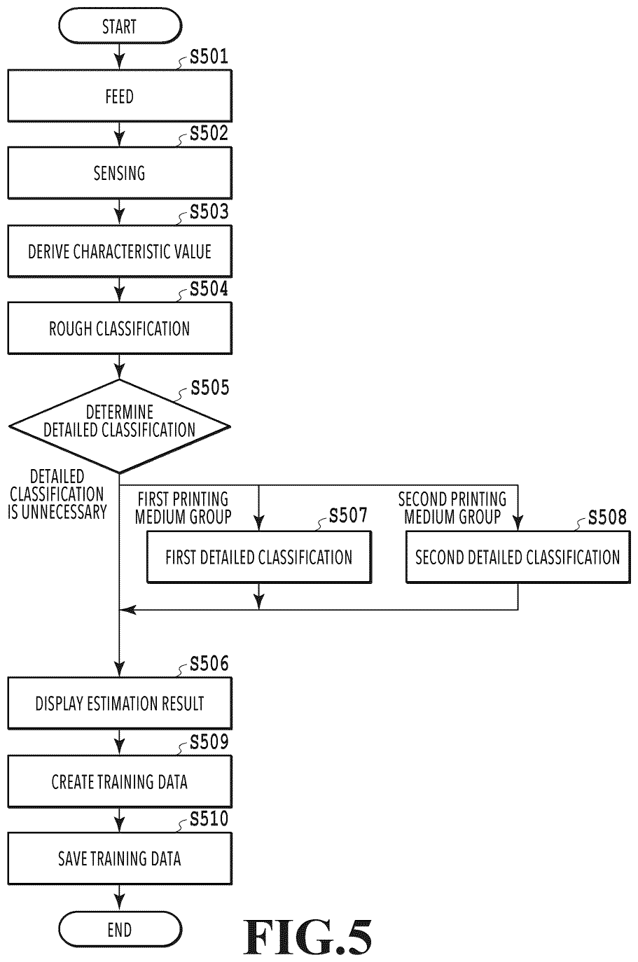

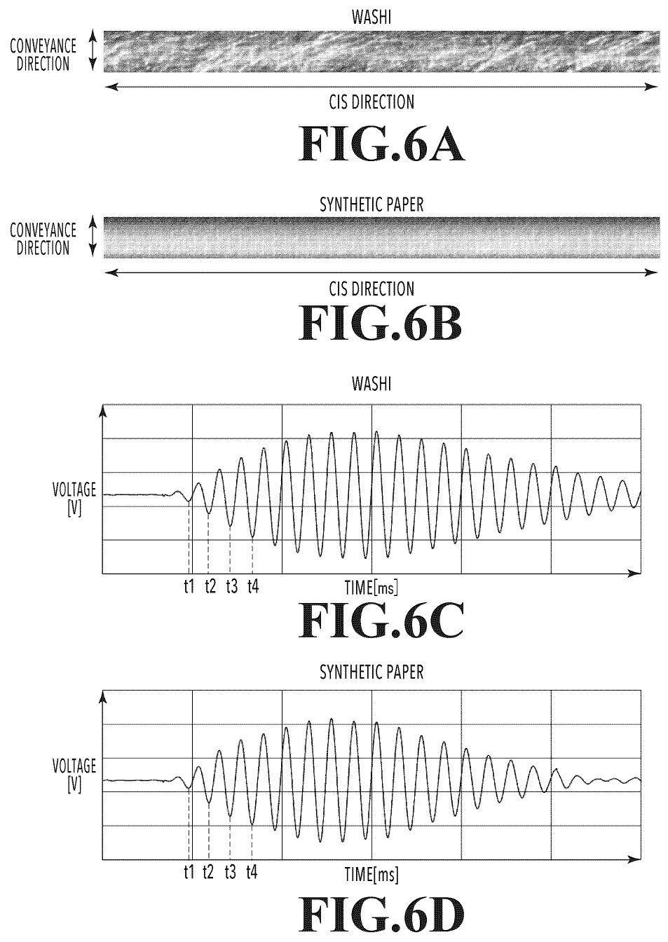

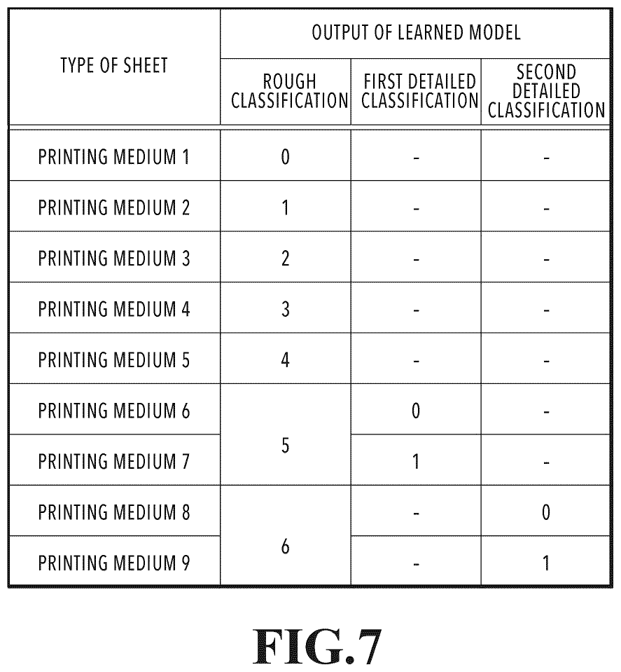

An operation of estimating the type of the sheet S in the present embodiment is described with reference to FIGS. 4 to 7. FIG. 4 is a cross-sectional view illustrating an example of the vicinity of the media sensor 206. FIG. 5 is a flowchart illustrating an example of processing of estimating the type of the fed sheet S. FIGS. 6A to 6D are diagrams each illustrating an example of data from detection of characteristics of the sheet S. FIGS. 6A to 6D are examples of the data from the detection of the characteristics of the sheet S by using each of the media sensor 206 and the ultrasonic wave transmission device 207. FIG. 7 is a diagram illustrating an example of an estimation table of the type of the sheet S in the present embodiment. The estimation table in FIG. 7 determines the type of the sheet S corresponding to an output value y of the learned model described later. In the present embodiment, there are nine types for the type of the sheet S as an estimation target, which are a printing medium 1 to a printing medium 9. That is, the learned model 352 that estimates the type of the sheet S is formed to estimate as the type of the sheet S a printing medium that is most appropriate for the inputted feature amount out of the printing medium 1 to the printing medium 9. Although it is described under the assumption that the learned model 352 is stored in the memory 305, the learned model 352 may be provided outside the printing apparatus 101, and the CPU 301 of the printing apparatus 101 may use the learned model 352 provided outside.

The processing in the flowchart illustrated in FIG. 5 is implemented with the CPU 301 of the printing apparatus 101 reading out the program 351 stored in the memory 305 and the like to the RAM 320 to execute. Note that, a part of or all the functions of steps in FIG. 5 may be implemented by hardware such as an ASIC or an electronic circuit. A sign “S” in each description of the processing means that it is a step in the flowchart (hereinafter, the same applies to a flowchart in the present specification). The processing illustrated in FIG. 5 is started with the user setting the roll sheet R in the printing apparatus 101, for example. Alternatively, the processing may be started with detection of an input of a predetermined operation to the operation panel 102 by the user after the user sets the roll sheet R in the printing apparatus 101. Hereinafter, the same applies to a flowchart described in the present specification.

In S501, the sheet S is fed. Specifically, the CPU 301 detects that the user sets the roll sheet R in the printing apparatus 101. The CPU 301 then rotates the roll sheet R by the roll driving motor 308. Thus, the sheet S is supplied from the roll sheet R to the conveyance roller 203. The sheet detection sensor 202 arranged upstream of the conveyance roller 203 then detects that the sheet S reaches the conveyance roller 203. Once the sheet detection sensor 202 detects that the sheet S reaches the conveyance roller 203, the CPU 301 stops driving the roll driving motor 308. In a position in which the sheet detection sensor 202 detects the sheet S, it is a state in which the sheet S is conveyed to a position in which the media sensor 206 and the ultrasonic wave transmission device 207 face each other. Thereafter, the CPU 301 allows the processing to proceed to S502.

In S502, the CPU 301 performs sensing. That is, the CPU 301 measures the characteristics of the sheet S by controlling the media sensor 206 and the ultrasonic wave transmission device 207 via the sensor control unit 302. As illustrated in FIG. 4, the media sensor 206 includes a contact image sensor (CIS) 401 and a microphone 402. A roller 403 is arranged in a position facing the CIS 401. The ultrasonic wave transmission device 207 is arranged in a position facing the microphone 402. It is possible to pinch the sheet S by using the CIS 401 and the roller 403 with the CPU 301 lowering the media sensor 206 distant from the sheet S by the media sensor elevating and lowering motor 313. It is possible to measure the characteristics of the sheet S stably by pinching the sheet S. The CPU 301 reads a surface image of the sheet S by the CIS 401 by conveying the sheet S again while pinching the sheet S by the CIS 401 and the roller 403. Then, in a case where the sensing ends, the CPU 301 moves the media sensor 206 away from the sheet S by elevating the media sensor 206 by the media sensor elevating and lowering motor 313.

FIGS. 6A and 6B illustrate an example of the surface image of the sheet S obtained by using the CIS 401. FIGS. 6C and 6D illustrate an example of an electric signal of an ultrasonic wave transmitted through the sheet S that is obtained by using the ultrasonic wave transmission device 207 and the microphone 402.

The CIS 401 is a line sensor extending in a width direction of the sheet S and obtains one-dimensional (one line of) image data. In a state in which the sheet S is pinched by using the CIS 401 and the roller 403, the CPU 301 obtains the image data of the sheet S by using the CIS 401 while synchronously driving the roll driving motor 308 and the conveyance roller driving motor 309. It is possible to obtain two-dimensional image data as illustrated in FIGS. 6A and 6B by reading the image of the sheet S by the CIS 401 while conveying the sheet S as described above. FIG. 6A is an example of a surface image of washi, and FIG. 6B is an example of a surface image of synthetic paper. In FIGS. 6A and 6B, a CIS direction corresponds to a width of the CIS 401 (a width in the X direction crossing the sheet S), and the conveyance direction corresponds to the conveyance amount of the sheet S that is measured by the CIS 401. Note that, although an example in which the measuring is performed by using a one-dimensional sensor as the CIS 401 is described in this case, the surface image of the sheet S may be measured by using a two-dimensional sensor. Additionally, in measuring the surface image by the CIS 401, the electric signal of the ultrasonic wave illustrated in FIGS. 6C and 6D is obtained by the ultrasonic wave transmission device 207 and the microphone 402 (a sound pickup sensor). FIG. 6C is an example of the electric signal of the ultrasonic wave transmitted through the washi, and FIG. 6D is an example of the electric signal of the ultrasonic wave transmitted through the synthetic paper. Although an example in which the electric signal of the ultrasonic wave is obtained with the measurement of the surface image by the CIS 401 is described in the present embodiment, it is not limited thereto. The measurement of the surface image and the obtainment of the electric signal of the ultrasonic wave may be performed separately. Additionally, the electric signal of the ultrasonic wave may be obtained while not conveying the sheet S. Thereafter, the CPU 301 allows the processing to proceed to S503.

In S503, the CPU 301 derives a characteristic value. Specifically, the CPU 301 derives a feature amount related to surface information of the sheet S and a feature amount related to cross-section information from the characteristics of the sheet S measured in S502 described above by using a method of deriving the feature amount that is saved in the memory 305 in advance. That is, the CPU 301 derives the feature amount related to the surface information of the sheet S and the feature amount related to the cross-section information from the surface image of the sheet S and the electric signal of the ultrasonic wave.

The CPU 301 derives three feature amounts related to the surface information of the sheet S from the surface image of the sheet S as illustrated in FIGS. 6A and 6B. The first feature amount is luminance. The luminance is derived as an average value of all the pixel values. The second feature amount is irregularities in the CIS direction. The irregularities in the CIS direction are derived as an average value of absolute values of differences between the pixel values adjacent to each other in the CIS direction. The third feature amount is irregularities in the conveyance direction. The irregularities in the conveyance direction are derived as an average value of absolute values of differences between the pixel values adjacent to each other in the conveyance direction.

The CPU 301 derives three feature amounts related to the cross-section information of the sheet S from the electric signal of the ultrasonic wave transmitted through the sheet S as illustrated in FIG. 6C and 6D. The first feature amount is a peak 1. The peak 1 is derived as the maximum voltage value in a period from time t1 to time t2. The second feature amount is a peak 2. The peak 2 is derived as the maximum voltage value in a period from the time t2 to time t3. The third feature amount is a peak 3. The peak 3 is derived as the maximum voltage value in a period from the time t3 to time t4. Note that, although it is described that the maximum voltage value is used in this case, the minimum voltage value may be applied. The cross-section information of the sheet S corresponds to information such as a thickness and a basis weight of the sheet.

Thus, in S503, the CPU 301 can derive the six feature amounts related to the surface information and the cross-section information of the sheet S from the characteristics of the sheet S measured in S502.

In the present embodiment, descriptions are provided using the washi and the synthetic paper as an example. Hereinafter, an example of a relationship between the feature amounts of the two types of paper is described. The luminance is higher in the synthetic paper than the washi. The irregularities in the CIS direction are greater in the washi than the synthetic paper. The irregularities in the conveyance direction are greater in the washi than the synthetic paper. For example, the higher luminance is obtained with the sheet S that is a sheet having a whiter shade of color and is a sheet having flatter surface properties. Additionally, the irregularities in the two directions, which are the CIS direction and the conveyance direction, are greater with the greater irregularities of the surface. Note that, depending on the type of the sheet, there is a vertical fiber orientation or a horizontal fiber orientation, and the irregularities in only either one may be great. The electric signal of the ultrasonic wave has the smaller peak value as the thickness of the sheet is thicker. The washi has the greater thickness than the synthetic paper. For this reason, the peak value is greater in the synthetic paper than the washi. Additionally, even with the same thickness, the peak value is changed depending on a cross-section (a material forming the sheet or a density). Specifically, there is a tendency that the peak value is reduced by using a material (a medium) that increases an acoustic impedance. Thereafter, the CPU 301 allows the processing to proceed to S504.

In S504, the CPU 301 classifies the type of the sheet S. That is, the CPU 301 estimates the type of the sheet S from the six feature amounts derived in S503 by using the learned model of the rough classification saved in advance in the memory 305 and the estimation table illustrated in FIG. 7. In order to estimate the type of the sheet S, the CPU 301 obtains the output value y outputted from the learned model of the rough classification. With the six feature amounts related to the sheet S that are derived in S503 being inputted, the learned model of the rough classification outputs a probability of being the type of the sheet S as the estimation target in the form of an array for each type of the sheet S. Elements in the output array are each associated with the type of the sheet S correspondingly. That is, an index of each element in the output array is associated with the type of each sheet correspondingly. In the present embodiment, the index of the element with the maximum probability in the output array is the output value y of the learned model of the rough classification. Additionally, the type of the sheet S associated with the output value y is the estimation result.

As illustrated in the estimation table in FIG. 7, in S504, in a case where the output value y obtained by inputting the feature amount of the sheet S to the later-described learned model of the rough classification is 0, the CPU 301 estimates the type of the sheet S as the printing medium 1. Likewise, the CPU 301 estimates the type of the sheet S as the printing medium 2 in a case where the output value y is 1, estimates as the printing medium 3 in a case where the output value y is 2, estimates as the printing medium 4 in a case where the output value y is 3, and estimates as the printing medium 5 in a case where the output value y is 4. In a case where the output value y is 5, the estimation result of the type of the sheet S is the printing medium 6 and the printing medium 7. In this case, the printing medium 6 and the printing medium 7 are collectively considered as a first printing medium group. That is, in a case where the output value y is 5, the CPU 301 estimates the type of the sheet S as the first printing medium group. Likewise, in a case where the output value y is 6, the estimation result of the type of the sheet S is the printing medium 8 and the printing medium 9. In this case, the printing medium 8 and the printing medium 9 are collectively considered as a second printing medium group. That is, in a case where the output value y is 6, the CPU 301 estimates the type of the sheet S as the second printing medium group. After the processing in S504, the CPU 301 allows the processing to proceed to S505.

Thus, in a case where the output value y outputted from the learned model of the rough classification is 0 to 4 in S504, the CPU 301 can uniquely estimate the type of the sheet S as the printing medium 1 to the printing medium 5, respectively. On the other hand, in a case where the output value y is 5, the CPU 301 estimates the type of the sheet S as the printing medium 6 and the printing medium 7. That is, in this case, the CPU 301 estimates that the type of the sheet S is classified as the first printing medium group in the rough classification. Likewise, in a case where the output value y is 6, the CPU 301 estimates that the type of the sheet S is classified as the second printing medium group in the rough classification. That is, in a case where the output value y is 5 and 6, the CPU 301 cannot uniquely estimate the type of the sheet S but uniquely estimates the type of the sheet S as a type of a printing medium group including multiple types of the printing medium. In the present embodiment, the characteristic values corresponding to the printing media 6 and 7 are close values within a predetermined range. Likewise, the characteristic values corresponding to the printing media 8 and 9 are close values within a predetermined range. Therefore, in the estimation using the learned model of the rough classification, a configuration that allows for the obtainment of the estimation result in the form of combining the multiple printing media is applied.

In S505, the CPU 301 determines whether to execute first detailed classification in S507 or second detailed classification in S508, which are described later, based on the estimation result of the type of the sheet S in S504. Specifically, in a case where the estimation result in S504 corresponds to the first printing medium group, the CPU 301 determines to execute the first detailed classification and allows the processing to proceed to S507. In a case where the estimation result in S504 corresponds to the second printing medium group, the CPU 301 determines to execute the second detailed classification and allows the processing to proceed to S508. In a case where the estimation result in S504 corresponds to neither first printing medium group nor second printing medium group, the CPU 301 allows the processing to proceed to S506. In S506, the CPU 301 displays the estimation result on the operation panel 102.

In S507, the CPU 301 estimates the type of the sheet S from the six feature amounts derived in S503 described above by using the learned model for the first detailed classification saved in advance in the memory 305 and the estimation table illustrated in FIG. 7. That is, in S507, the CPU 301 estimates the type of the sheet S by using the same feature amounts as the six feature amounts used in the estimation of the type of the sheet S in S504. Note that, the output value y obtained in S507 is an output value of another learned model different from the learned model used in S504. That is, if the learned model used in S504 is a first learned model, the learned model used in S507 is a second learned model different from the first learned model. In this case, the different learned models are at least models that perform the learning by using different data as the data used for the learning. In order to estimate the type of the sheet S, the CPU 301 obtains the output value y of the learned model as with S504 described above.

As illustrated in the estimation table in FIG. 7, in S507, in a case where the output value y obtained by inputting the feature amount of the sheet S to the learned model for the first detailed classification is 0, the CPU 301 estimates the type of the sheet S as the printing medium 6. Likewise, in a case where the output value y is 1, the CPU 301 estimates the type of the sheet S as the printing medium 7. Thereafter, the CPU 301 allows the processing to proceed to S506. Thus, in S507, the CPU 301 can uniquely estimate the type of the sheet S that is estimated as the first printing medium group in S504 as the printing medium 6 or the printing medium 7.

In S508, the CPU 301 estimates the type of the sheet S from the six feature amounts derived in S503 described above by using the learned model for the second detailed classification saved in advance in the memory 305 and the estimation table illustrated in FIG. 7. That is, in S508, the CPU 301 estimates the type of the sheet S by using the same feature amounts as the six feature amounts used in the estimation of the type of the sheet S in S504. Note that, the output value y obtained in S508 is an output value of the learned model different from that in S504 and S507. In S508, in order to estimate the type of the sheet S, the output value y of the learned model for the second detailed classification is obtained as with S504 and S507 described above.

As illustrated in the estimation table in FIG. 7, in S508, in a case where the output value y obtained by inputting the feature amount of the sheet S to the learned model of the second detailed classification is 0, the CPU 301 estimates the type of the sheet S as the printing medium 8. Likewise, in a case where the output value y is 1, the CPU 301 estimates the type of the sheet S as the printing medium 9. Thereafter, the CPU 301 allows the processing to proceed to S506. Thus, in S508, the CPU 301 can uniquely estimate the type of the sheet S that is estimated as the second printing medium group in S504 as the printing medium 8 or the printing medium 9.

In S506 that is subsequent to S507 and S508, the CPU 301 also displays the estimation result on the operation panel 102 as described above. Once the processing in S506 ends, the CPU 301 allows the processing to proceed to S509.

In S509, the CPU 301 creates training data used to update the learned model. The training data is a type of a learning parameter used for the learning of the learned model. This training data includes the feature amount of the sheet S obtained in S503 and the information related to the type of the sheet S (the estimation result) obtained in S506. In S510, the CPU 301 saves the created training data in a saving destination. Even in a case where the printing media are the same type, the characteristic values may not be completely the same depending on individual variability. Therefore, even in a case where the type of the sheet S can be properly estimated, it is possible to optimize the learned model as needed by saving the characteristic value used in the estimation and the estimation result as the training data and using the training data to update the learned model. Note that, the training data created and saved in this process is data used in each learned model, correspondingly. For example, a case where the estimation result in S506 is the printing medium 6 is assumed. In this case, the estimation result indicating the first printing medium group as the estimation result is used as the training data for the learned model used for the rough classification. On the other hand, the estimation result indicating the printing medium 6 as the estimation result is used as the training data for the learned model used for the first detailed classification. Thus, in a case where the detailed classification is performed, the training data for the detailed classification is created and saved in addition to the training data for the rough classification.

Note that, the saving destination of the training data is preferably the same as the saving destination to which an apparatus or a system that updates the learned model belongs. This is for reduction of various costs required to update the learned model. Accordingly, in a configuration of updating the learned model inside the printing apparatus 101, the saving destination of the training data may be the memory 305 illustrated in FIG. 3. In a configuration of updating the learned model by external equipment other than the printing apparatus 101, the saving destination of the training data is a not-illustrated machine learning apparatus. The machine learning apparatus may be a personal computer (PC) of the user or may be a server PC. Additionally, the machine learning apparatus may be a server system including multiple servers. In a case where the parameter for the learning is transferred from the printing apparatus 101 to an external storage apparatus, the transfer may be performed via the USB port 304 or a local area network (LAN) port 314.

### <Learned Model>

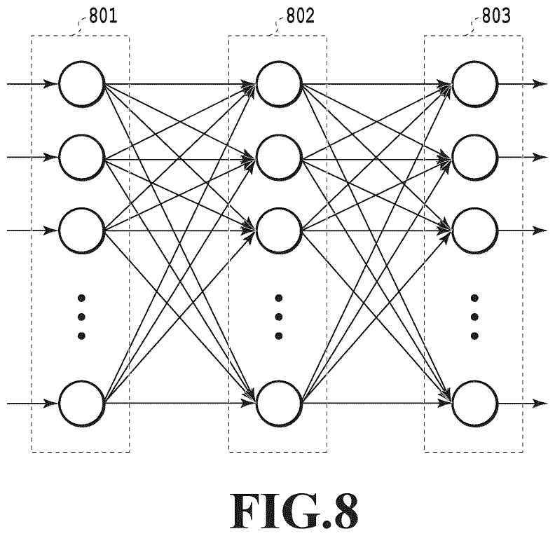

FIG. 8 is a schematic diagram of a deep neural network (DNN). The three learned models 352 described above in the present embodiment are described with reference to FIG. 8.

The learned model 352 in the present embodiment is a DNN as illustrated in the schematic diagram in FIG. 8. The DNN receives the data by an input layer 801, propagates the data via an intermediate layer 802, and outputs the data by an output layer 803. Each layer includes multiple nodes represented by circles. The inputted data is propagated toward the output layer while weighting, biasing, and the like are performed between the nodes of the layers. Adjustment of the parameter such as weighting and biasing to allow for the designated output for the designated input is expressed as the learning of the model. Additionally, the model that is learned is called the learned model. A data set of the input data used for the learning of the model and the output data associated thereto is called the training data as described above.

The input data of the training data in the present embodiment is the six feature amounts prepared for each type of the sheet S. The six feature amounts are the luminance, the irregularities in the CIS direction, the irregularities in the conveyance direction, the peak 1, the peak 2, and the peak 3, which are equal to the feature amounts derived in S503 described above. In the present embodiment, the same feature amounts are used in the learning of all the models. Additionally, the input layer 801 of the learned model includes six nodes. The feature amounts are inputted to the nodes, respectively.

The output data of the training data in the present embodiment is an integer value indicating the type of the sheet S as the estimation target. In a case where there are two types of the sheet S as the estimation target, the output data of the training data is 0 or 1. In a case where there are seven types of the sheet S as the estimation target, the output data of the training data is 0 to 6. In the actual learning of the model, a one-hot vector converted from the integer value is used. In the present embodiment, a different combination of the types of the sheet S is used for each model to be learned. Additionally, the output layer 803 of the learned model includes the same number of nodes as that of the types of the sheet S as the estimation target. A probability that the sheet S is the type of each sheet is outputted from the corresponding node. Assuming that the output of the learned model as an array, it is possible to consider that each element of the output array is the probability of being the type of each sheet. If each element of the output array is associated with the type of each sheet, an index of each element is also associated with the type of each sheet. In the present embodiment, the estimation result of the learned model is the index of the element with the highest probability.

The first learned model is the learned model of the rough classification used in S504 described above. The types of the sheet S as the estimation target are all the printing media from the printing medium 1 to the printing medium 9. Note that, in view of the difficulty of the accurate estimation of all the printing media by using a single learned model, the types of the sheet S having similar characteristics are combined in advance into one group. In the present embodiment, the printing medium 6 and the printing medium 7 are combined into one group as the first printing medium group. Likewise, the printing medium 8 and the printing medium 9 are combined into one group as the second printing medium group. The output data of the training data of the rough classification is the integer value indicating the type of the sheet S, which is 0 corresponding to the printing medium 1, 1 corresponding to the printing medium 2, 2 corresponding to the printing medium 3, 3 corresponding to the printing medium 4, 4 corresponding to the printing medium 5, 5 corresponding to the first printing medium group, and 6 corresponding to the second printing medium group.

The learned model learned by using the above-described training data is the learned model of the rough classification. In the learned model of the rough classification, as illustrated in FIG. 7, in a case where the feature amounts corresponding to the printing medium 1 to the printing medium 9 are inputted, 0 to 6 are outputted as the corresponding estimation results. In a case where the feature amount corresponding to the printing medium 6 or the printing medium 7 is inputted, 5 is outputted as the estimation result. In a case where the feature amount corresponding to the printing medium 8 or the printing medium 9 is inputted, 6 is outputted as the estimation result.

The second learned model is the learned model of the first detailed classification used in S507 described above. The types of the sheet S as the estimation target are the printing medium 6 and the printing medium 7. The output data of the training data of the first detailed classification is the integer value indicating the type of the sheet S, which is 0 corresponding to the printing medium 6 and 1 corresponding to the printing medium 7.

The learned model learned by using the above-described training data is the learned model of the first detailed classification. In the learned model of the first detailed classification, as illustrated in FIG. 7, in a case where the feature amount corresponding to the printing medium 6 or the printing medium 7 is inputted, 0 or 1 is outputted as the corresponding estimation result.

A third learned model is the learned model of the second detailed classification used in S508 described above. The types of the sheet S as the estimation target are the printing medium 8 and the printing medium 9. The output data of the training data of the second detailed classification is the integer value indicating the type of the sheet S, which is 0 corresponding to the printing medium 8 and 1 corresponding to the printing medium 9.

The learned model learned by using the above-described training data is the learned model of the second detailed classification. In the learned model of the second detailed classification, as illustrated in FIG. 7, in a case where the feature amount corresponding to the printing medium 8 or the printing medium 9 is inputted, 0 or 1 is outputted as the corresponding estimation result.

The above-described three learned models are generated by the not-illustrated machine learning apparatus. The machine learning apparatus is a PC, for example. The machine learning apparatus can record the learned model and a computation method necessary for the estimation using the learned model in the memory 305 via the USB port 304, the input and output IF 303, and the CPU 301. The CPU 301 measures the characteristics of the sheet S by using the media sensor 206 and the ultrasonic wave transmission device 207, derives the feature amounts related to the surface information and the cross-section information of the sheet S from the measurement data, and estimates the type of the sheet S by inputting the derived feature amounts to the learned model.

In the example described thus far, the estimation uses the learned model created by the not-illustrated machine learning apparatus based on the training data of the printing medium determined in advance. That is, in the example in FIG. 7, the estimation using the learned model learned to estimate the printing media from the printing medium 1 to the printing medium 9 is performed. On the other hand, in some cases, another printing medium different from the type of the printing medium determined in advance is mounted on the printing apparatus 101. In this case, the learned model is demanded to be updated for the newly mounted printing medium.

For example, here, a method is described with reference to FIG. 7 as an example. It is possible to consider that the learned model is updated so as to add a new printing medium such as a printing medium 10 and a printing medium 11 in addition to the printing media 1 to 9 to the printing medium as the estimation target. However, as the variety of the types of the printing medium is increased, that is, as the variety of the values that may be obtained as the output value y of the learned model is increased, the parameter and the like of the learned model become complicated. As a result, there is a possibility that the capacity of the learned model is increased and the operation speed is decreased. On the other hand, it is possible to avoid the phenomenon by confining the variety of the types of the printing medium within a certain range, that is, by limiting the variety of the values that may be obtained as the output value y of the learned model to a predetermined value. For example, the example of the estimation table in FIG. 7 is an example in which seven types are registered as the types of the printing medium as the estimation target while also including the printing medium group as one of the types. Additionally, as described in the rough estimation classification, as the number of the estimation targets is reduced, it is possible to improve the estimation accuracy. Although it is possible to mount 100 or more types of the printing media on the printing apparatus 101 of the present embodiment, the number of the printing media that the user actually uses is likely to be within a predetermined range (for example, 10 types).

In the present embodiment, taking into consideration the above-described points and according to the usage trend and the like of the printing medium by the user, processing of updating the learned model is described. Hereinafter, a method of changing the printing medium as the estimation target and a method of updating the learned model are described. In the present embodiment, descriptions are given assuming that the printing medium as the estimation target is changed by the printing apparatus 101 and an operation to update the learned model is performed by the not-illustrated machine learning apparatus.

### <Method of Changing Printing Medium as Estimation Target>

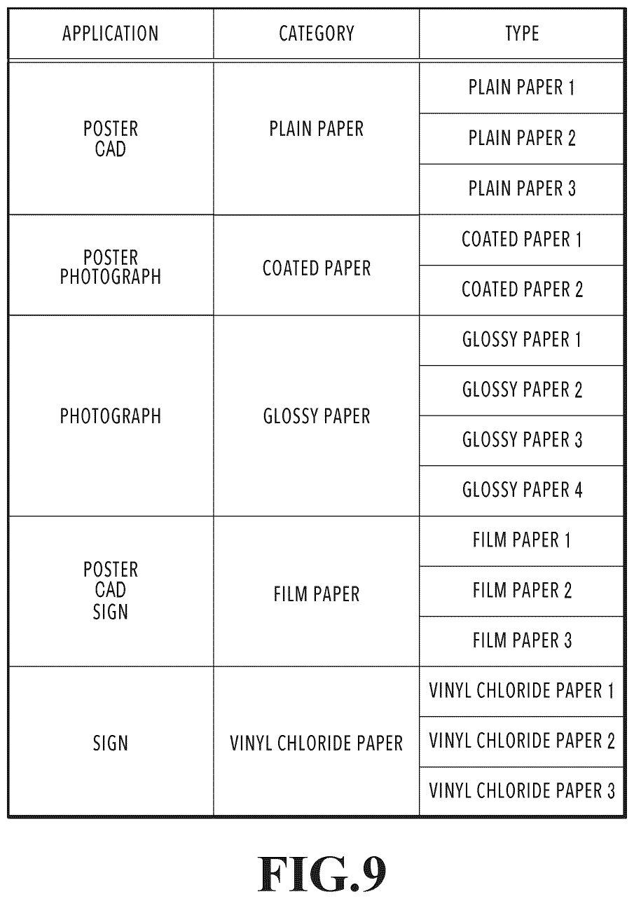

The method of changing the printing medium as the estimation target is described with reference to FIGS. 9 to 16. In the changing of the printing medium as the estimation target, processing of selecting the printing medium to be estimated is performed. The user can select the method of selecting the printing medium from either manual selection or automatic selection by using the operation panel 102. The processing of changing the printing medium by the manual selection is referred to as first change processing, and the processing of changing the printing medium by the automatic selection is also referred to as second change processing.

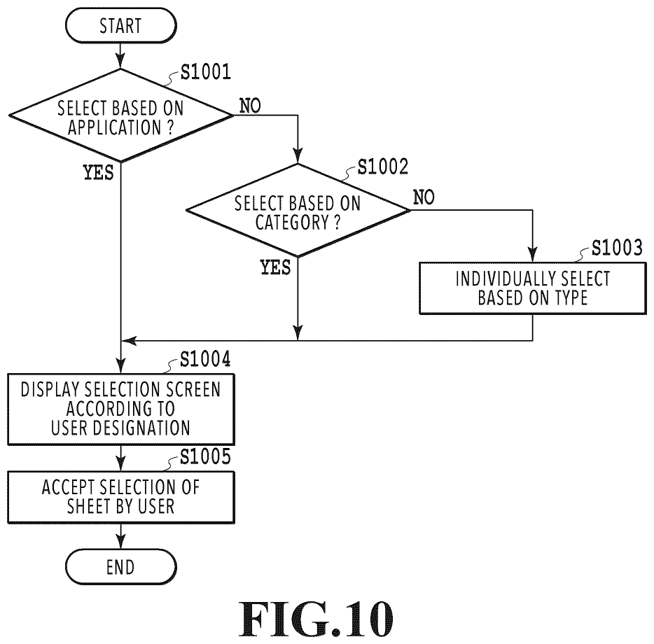

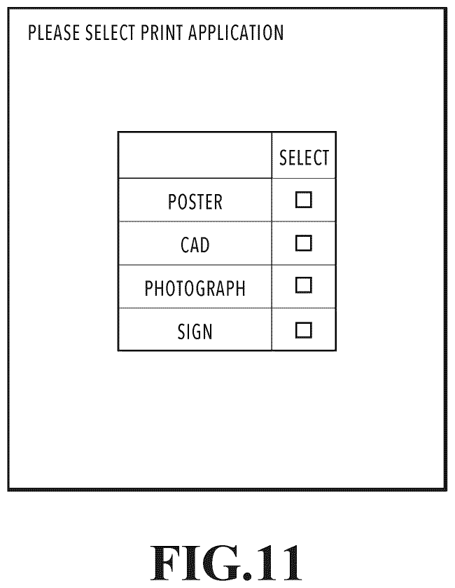

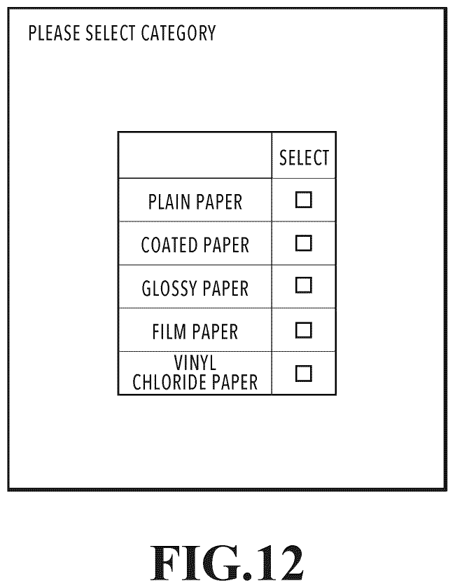

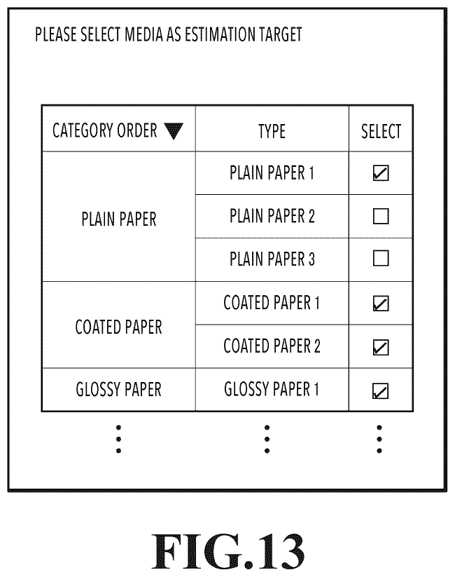

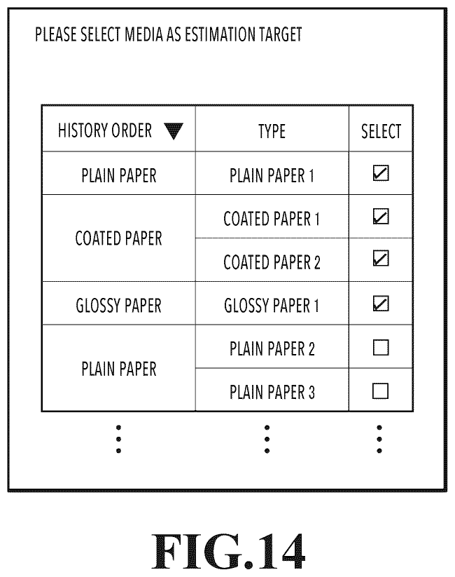

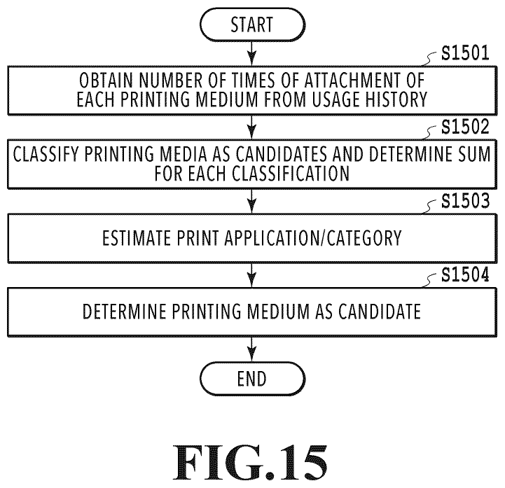

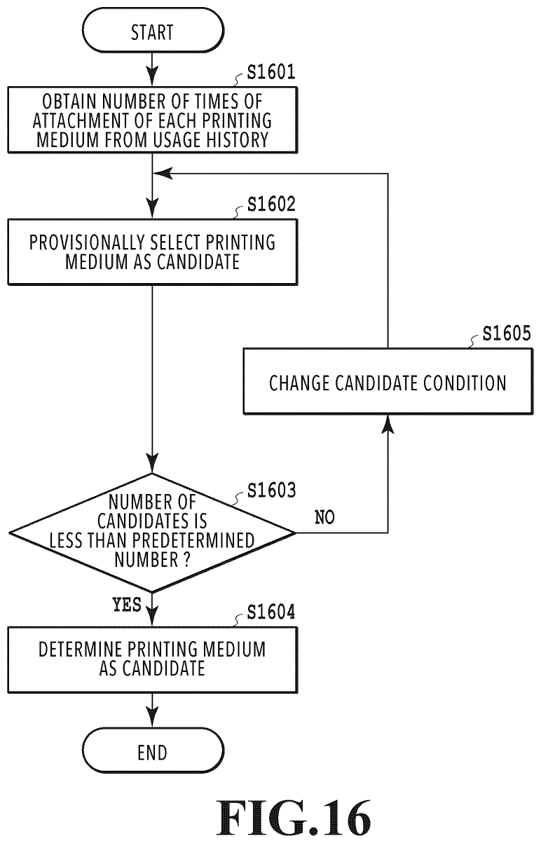

FIG. 9 is a list tabulating a print application, a category, and the type of the printing medium. FIG. 10 is a flowchart illustrating an example of the processing of the manual selection. FIG. 11 is a screen example of a case of application selection in the manual selection. FIG. 12 is a screen example of a case of category selection in the manual selection. FIG. 13 is a diagram illustrating an example of displaying the list in a usage history order in a case where the individual selection is performed in the manual selection. FIG. 14 is a diagram illustrating an example of displaying the list in the usage history order in a case of where the individual selection is performed in the manual selection. FIG. 15 is a flowchart illustrating an example of an operation of first processing of the automatic selection. FIG. 16 is a flowchart illustrating an example of an operation of second processing of the automatic selection.

The list illustrated in FIG. 9 is a list of the types of the printing medium that may be the estimation target in the printing apparatus 101, and the list is stored in the memory 305 or the like, for example. Note that, it is possible to update the list as needed. Additionally, the example illustrated in FIG. 9 is merely an example, and it is not limited to this example. Hereinafter, an example in which the printing medium as the estimation target is changed from the list illustrated in FIG. 9 is described. In FIG. 9, the types of the printing medium corresponding to the category are associated. The category also corresponds to the print application. For example, one print application may correspond to multiple categories. Specifically, in a case where the print application is “poster”, the category corresponds to all the “plain paper”, “coated paper”, and “film paper”. As illustrated in FIG. 9, each of “print application” and “category” is a classification by a group unit that comprehends multiple types of the printing medium.

First, the processing of the manual selection is described. In a case where “manual” is selected by the user as the method of changing the printing medium on a change screen (not illustrated) displayed on the operation panel 102 to change the printing medium as the estimation target, the processing illustrated in FIG. 10 is started.

The processing in the flowchart illustrated in FIG. 10 is implemented with the CPU 301 of the printing apparatus 101 reading the program 351 stored in the memory 305 or the like and reading out to the RAM 320 to execute. Note that, a part of or all the functions in the steps in FIG. 5 may be implemented by hardware such as an ASIC or an electronic circuit. The same applies to the flowchart of the automatic selection illustrated in FIGS. 15 and 16.

In the manual selection processing illustrated in FIG. 10, according to the designation by the user on the operation panel 102, selection according to the print application, all-at-once selection based on the category of the printing medium, or individual selection from the types of the printing medium is performed.

In S1001, the CPU 301 determines whether the user designates that the selection is performed by using the print application. For example, the CPU 301 displays a screen on the operation panel 102 to allow the user to designate whether the selection is performed by using the print application and performs determination based on an operation instruction by the user. If the user designates that the selection is performed by using the print application, the CPU 301 allows the processing to proceed to S1004. If the user does not designate that the selection is performed by using the print application, the CPU 301 allows the processing to proceed to S1002.

In S1002, the CPU 301 determines whether the user designates that the selection is performed by using the category of the printing medium. For example, the CPU 301 displays a screen on the operation panel 102 to allow the user to designate whether the selection is performed by using the category and performs determination based on the operation instruction by the user. If the user designates that the selection is performed by using the category of the printing medium, the CPU 301 allows the processing to proceed to S1004. If the user does not designate that the selection is performed by using the category of the printing medium, the CPU 301 allows the processing to proceed to S1003.

In S1003, the CPU 301 determines that the user designates that the selection is performed individually by using the types of the printing medium and allows the processing to proceed to S1004. Note that, although an example in which S1001, S1002, and S1003 are processed sequentially is described in the present example, it is not limited to this example. For example, designation processing corresponding to S1001, S1002, and S1003 may be performed based on a single designation operation by the user through the operation panel 102.

In S1004, the CPU 301 displays a selection screen according to the designation by the user in S1001, S1002, and S1003.

In S1001, if the selection based on the application is designated, the CPU 301 displays the selection screen illustrated in FIG. 11, for example. In FIG. 11, “poster”, “CAD”, “photograph”, and “sign” are displayed as the print application on the operation panel 102. On this selection screen, once the user selects the print application displayed on the operation panel 102, the printing media allocated to each print application are selected all at once as illustrated in FIG. 9. For example, in a case where “photograph” is selected on the selection screen in FIG. 11, the CPU 301 selects coated paper 1 to 2 and glossy paper 1 to 4 as illustrated in FIG. 9. Note that, a configuration that allows the user to select multiple print applications may be applied. The selection screen in FIG. 11 is provided with checkboxes to allow the user to designate multiple applications. For example, in a configuration that allows the user to select up to two types of the print applications, if the print applications “poster” and “CAD” are selected, the CPU 301 selects plain paper 1 to 3, the coated paper 1 to 2, and film paper 1 to 3 as illustrated in FIG. 9. Thus, the user can manually select the printing medium proper for the print application. That is, the user can select the printing medium proper for the print application on a voluntary basis of the user. Such a selection method is appropriate for a case of using the printing apparatus 101 for an application other than the previous print application, for example.

In S1002, if the selection based on the category is designated, the CPU 301 displays the selection screen illustrated in FIG. 12, for example. In FIG. 12, “plain paper”, “coated paper”, “glossy paper”, “film paper”, and “vinyl chloride paper” are displayed on the operation panel 102 as the category of the printing medium. On this selection screen, once the user selects the category displayed on the operation panel 102, the printing medium allocated to each category is selected as illustrated in FIG. 9. Note that, a configuration that allows the user to select multiple categories may be applied. For example, in a configuration that allows the user to select up to two types of the categories, if “plain paper” and “coated paper” are selected, the plain paper 1 to 3 and the coated paper 1 to 2 are selected as illustrated in FIG. 9. Thus, the user can select the printing medium proper for the category of the printing medium. Such a selection method is appreciated for a case of using the printing medium of a category other than the category used previously in the printing apparatus 101, for example.

In S1003, if the individual selection of the type of the printing medium is designated, the CPU 301 displays a selection screen as illustrated in FIG. 13 or 14, for example. FIG. 13 is a selection screen tabulating and displaying the types of the printing medium on the operation panel 102 in the category order. FIG. 14 is a selection screen displaying the types of the printing medium while prioritizing the type of the printing medium having the usage history. FIGS. 13 and 14 both illustrate a situation where the plain paper 1, the coated paper 1 to 2, and the glossy paper 1 are individually selected. Thus, the user can select multiple printing media as the estimation target from the displayed types of the printing medium.

Note that, in the present embodiment, in any of the cases of using the selection methods, which are “application”, “category”, and “type”, illustrated in FIG. 9, the number of the types of the printing medium as the estimation target is not limited. One type of the printing medium may be selected, or multiple types of the printing medium may be selected. Additionally, here, an example in which the user selects the type of the printing medium as the estimation target estimated in the printing apparatus 101 is described. That is, an example in which the type of the printing medium selected in FIGS. 11 to 14 is the type of the printing medium as the estimation target in the printing apparatus 101 is described. That is, an example in which the changing of the printing medium means that the types of the printing medium used as the estimation target in the current printing apparatus 101 are all changed is described. However, it is not limited to this example. For example, the user may select in advance an unnecessary type of the printing medium out of the types of the printing medium used as the estimation target in the current printing apparatus 101 through a not-illustrated selection screen. Additionally, instead, the type of the printing medium selected in FIGS. 11 to 14 may be added as the type of the printing medium as the estimation target. Moreover, a configuration in which the type of the printing medium selected in FIGS. 11 to 14 is added as the type of the printing medium as the estimation target without selecting an unnecessary type of the printing medium may be applied. In any case, as described above, in a case where the number of the types of the printing medium exceeds a predetermined range, there is a possibility that various costs of the learned model are increased, and the estimation accuracy is decreased. Therefore, it is preferred to change the printing medium as the estimation target so that the number of the types of the printing medium does not exceed the predetermined range. Therefore, for example, in a case where the number of the types of the printing medium of a manually selected result exceeds a predetermined range, the user may receive a warning. Note that, as an example of the predetermined range, the number of the types of the printing medium is two to ten; however, this is an example, and it is not limited to this range.

The above is an example of the processing of the manual selection. Next, processing of the automatic selection is described. Unlike the manual selection, the automatic selection is processing in which the CPU 301 determines the type of the printing medium as the estimation target according to a predetermined condition without a selection instruction by the user. In the automatic selection processing in the present embodiment, the CPU 301 automatically selects the printing medium as the estimation target based on the usage history of the printing medium in the printing apparatus 101. Here, the usage history can be information based on a count value of the number of times of attaching the printing medium fed by the printing apparatus 101. An execution timing of the automatic selection processing can be a case where the number of times of feeding in the usage history exceeds a certain number of times, for example. Additionally, the CPU 301 may execute the automatic selection processing periodically by using a clock function inside the printing apparatus 101. In the present embodiment, two types of processing, which are the first processing and the second processing, are described as the automatic selection processing.

First, the first processing of the automatic selection is described with reference to FIGS. 9 and 15. The first processing is processing in which the print application of the user is estimated from the usage history and determines the printing medium as the estimation target according to the estimated print application.

The first processing is described with reference to the flowchart in FIG. 15. In S1501, the CPU 301 obtains the number of times of attachment (the count value) of each printing medium from the usage history. In S1502, the CPU 301 classifies the printing media as candidates from which the number of times of attachment is obtained in S1501 based on each “application” illustrated in FIG. 9 and determines the sum of the number of times of attachment of the printing medium for each application. For example, in a case where the number of times of attachment of the printing medium obtained in S1501 is five times for the glossy paper 1, three times for the glossy paper 2, two times for the coated paper 1, and two times for the film paper 1, the sum for each application is ten times for “photograph”, which is the sum of the glossy paper 1, the glossy paper 2, and the coated paper 1. The sum for “poster” is four times, which is the sum of the coated paper 1 and the film paper 1. The sum for “CAD” is two times, which is based on only the film paper 1, and the sum for “sign” is two times, which is based on only the film paper 1.

Next, in S1503, the CPU 301 compares the sums of the count values determined in S1502 and estimates the application corresponding to the top count value as the print application. In the above-described example, the sums of the count values are ten times for “photograph”, four times for “poster”, two times for “CAD”, and two times for “sign”. Here, in a case of a configuration in which up to two print applications can be selected in the printing apparatus 101, the two applications, “photograph” and “poster”, are selected. Next, in S1504, the CPU 301 determines the type of the printing medium corresponding to the estimated application as the printing medium as a candidate of the estimation target. For example, in a case where “photograph” and “poster” are selected as the print application, the glossy paper 1 to 4, the coated paper 1 to 2, and the film paper 1 to 3 are determined as the printing medium as the estimation target.

Note that, although an example in which the sums of the count values are compared to estimate the print application in S1503 is described in the above-described example, a ratio may be calculated from the count values, and the application corresponding to the count value with a high ratio may be estimated as the print application.

Additionally, although an example in which the print application is automatically estimated from the usage history is described in the above-described example, the category may be automatically estimated from the usage history. That is, a configuration in which the printing medium is classified by “category” illustrated in FIG. 9 in S1502, the category with a high usage frequency is estimated in S1503, and the printing medium belonging to the estimated category is automatically determined in S1504 may be applied. For example, in a case where the count values obtained in S1501 are five times for the glossy paper 1, three times for the glossy paper 2, two times for the coated paper 1, and one time for the film paper 1, the sums for each category are eight times for “glossy paper”, two times for “coated paper”, and one time for “film paper”. In S1503, the CPU 301 compares the count values obtained in S1503, and in a case of a configuration in which up to two categories can be selected, for example, “glossy paper” and “coated paper” positioned as the top are estimated as the category. In S1504, the CPU 301 determines the type of the printing medium corresponding to the estimated category as the printing medium as the candidate of the estimation target. For example, in a case where “glossy paper” and “coated paper” are selected as the category, the glossy paper 1 to 4 and the coated paper 1 to 2 are determined as the printing medium as the estimation target. The above is an example of the first processing.

In the first processing, the printing medium corresponding to the application or the category based on the usage history is automatically determined as the printing medium as the estimation target. Therefore, an unused type of the printing medium may be determined as the type of the printing medium as the estimation target.

Next, an example of the second processing of the automatic selection is described with reference to the flowchart illustrated in FIG. 16. The second processing of the automatic selection is processing in which the type of each printing medium is automatically and individually selected from the usage history and determined as the estimation target.

In S1601, the CPU 301 obtains the number of times of attachment of each printing medium from the usage history. Next, in S1602, the CPU 301 selects the printing medium that is attached a predetermined number of times or more as a provisional candidate. For example, in a case where the same type is attached three times or more, the printing medium is selected as the provisional candidate. Next, in S1603, the CPU 301 determines whether the number of the provisional candidates selected in S1602 is less than a predetermined number. If the number is less than the predetermined number, the processing proceeds to S1604, and the CPU 301 determines the type of the printing medium as the provisional candidate as the type of the printing medium that is the candidate of the estimation target. For example, in a case where the predetermined number is ten, and if the number of the provisional candidates actually selected is nine, the types of the printing medium of those nine candidates are determined in S1604 as the type of the printing medium as the estimation target.

On the other hand, if the number of the provisional candidates is equal to or more than the predetermined number in S1603, the CPU 301 allows the processing to proceed to S1605. In S1605, the CPU 301 changes the candidate condition for the selection as the provisional candidate. For example, “1” is added to the number of times of attachment of the printing medium used to select the provisional candidate, and the processing returns to S1602 to execute the provisional candidate selection again. In this case, in the second S1602, the printing medium of the same type that is attached four times or more is selected as the provisional candidate. Thus, the processing is repeated until the condition in S1603 is satisfied, and the estimation target of the printing medium is determined eventually in S1604.

In the second processing, the printing medium as the estimation target is automatically determined based on the usage history of the individual printing medium. Therefore, unlike the first processing, a configuration in which the unused type of the printing medium is basically not determined as the type of the printing medium as the estimation target is applied. Therefore, the second processing is useful for the optimization in a scene in which the unused printing medium is not used newly, for example.

With the first processing and the second processing of the automatic selection being used as above, it is possible to automatically determine the estimation target of the printing medium according to the usage history. Note that, as for the selection of whether to apply the first processing or the second processing, as described above, a configuration that allows the user to select the first processing or the second processing concurrently with the acceptance of the selection of either the manual selection or the automatic selection from the user may be applied. Alternatively, a configuration that allows the user to select whether to perform the first processing or the second processing after accepting the automatic selection may be applied.

### <Update of Learned Model>

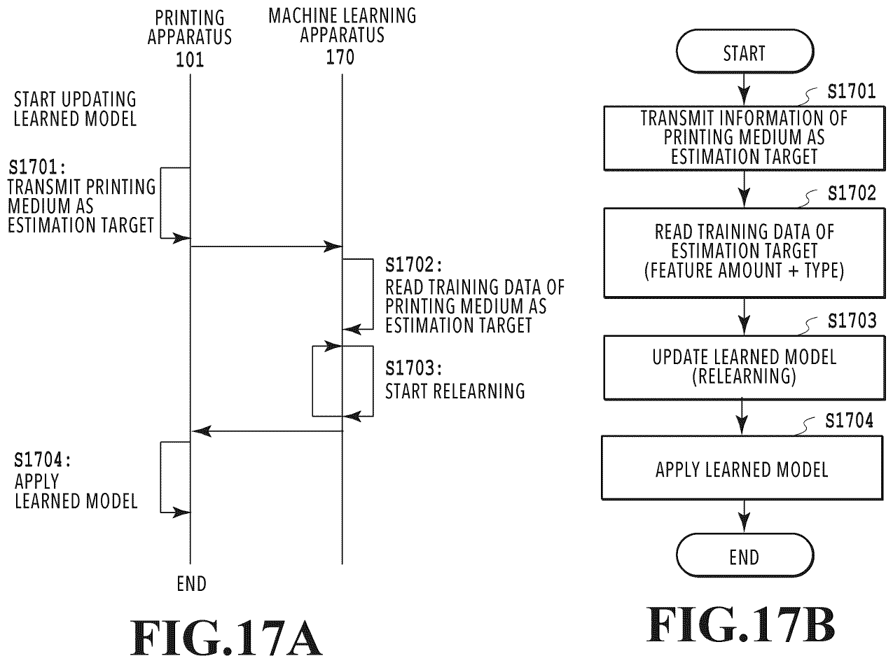

FIGS. 17A and 17B are diagrams each illustrating an example of processing of updating the learned model. FIG. 17A is a transition diagram of the processing of updating the learned model. FIG. 17B is a flowchart illustrating an example of the processing of updating the learned model in a system updating the learned model. In the present embodiment, a series of processing of updating the learned model is performed by using the printing apparatus 101 and a machine learning apparatus 170. A step number illustrated in FIG. 17A and a step number illustrated in FIG. 17B indicate the same step. Hereinafter, a method of updating the learned model that is used in S504 in FIG. 5 is described with reference to FIGS. 17A and 17B.

S1701 and S1704 are processing executed by the printing apparatus 101. S1702 and S1703 are processing executed by the machine learning apparatus 170.

In S1701, the printing apparatus 101 transmits the information indicating the type of the printing medium as the estimation target determined by the above-described manual setting or automatic setting to the machine learning apparatus 170. That is, the printing apparatus 101 transmits the information indicating the type of the printing medium that should be registered as the estimation target to the machine learning apparatus 170. In S1702, the machine learning apparatus 170 reads the training data coinciding with the transmitted type of the printing medium as the estimation target. Note that, the machine learning apparatus 170 holds the training data of the type of the printing medium determined in advance. This training data holds information related to the feature amounts and the type of the printing medium derived by the same method as that in S503 and S506 described above. Additionally, the machine learning apparatus 170 also holds the training data saved in S510. Accordingly, in S1702, the machine learning apparatus 170 reads the information of the printing medium saved in advance in the machine learning apparatus 170 that coincides with the estimation target transmitted in S1701 as the training data.

Next, in S1703, the machine learning apparatus 170 updates the learned model by using the obtained training data. The update of the learned model may be a method by the machine learning using the deep neural network (DNN) described above with reference to FIG. 8. The input data of the training data of the DNN inputs the feature amounts of each printing medium. The output data of the training data of the DNN sets the information indicating the type of each printing medium. Thus, the machine learning apparatus updates the learned model by relearning the training data related to the printing medium as the estimation target. Finally, in S1704, after detecting the completion of the update of the learned model in S1703, the printing apparatus 101 performs processing of replacing with the learned model in the printing apparatus 101.

Note that, as described above, the learned model used in S504 is the learned model used for the rough classification. Accordingly, the training data may be processed to estimate a result such that the printing media with a difference between the feature amounts within a predetermined range, that is, the printing media having similar feature amounts are estimated as the printing medium group.

Additionally, although an example of updating the learned model used in S504 is described herein, it is possible to perform the update similarly on also the learned model used for the detailed classification in S507 or S508.

### <Example of Utilization Form>

Next, an example of a specific utilization form to which the above-described embodiment is applied is described. First, in a case where the printing apparatus 101 is newly introduced and installed, the type of the printing medium as the estimation target is determined by the manual selection by the user. Thereafter, according to the usage of the printing apparatus 101, the types of the printing medium as the estimation target diverge into the printing medium being used and the printing medium not being used. Therefore, the relearning is performed such that the printing medium with a high usage frequency is used as the printing medium as the estimation target by the automatic selection based on the usage history in a proper timing. In other words, it is also possible to say that the relearning processing is performed so as to remove the type of the printing medium with a low usage frequency from the estimation target.

Additionally, as the printing media are used, a totally new printing medium may be attached to the printing apparatus 101. Although an example in which the probability of the classification result is outputted in the processing of displaying the estimation result in S506 described above is described, an error may be outputted as the estimation result in S506 in a case where the probability is equal to or lower than a predetermined probability. In a case where a totally new printing medium is attached, in response to the output of the error, the user changes the printing medium as the estimation target by the manual selection, and the relearning is performed based on this change. As described above, since the training data of each printing medium is saved in the machine learning apparatus 170, the learned model that performs the relearning by using the training data of the printing medium corresponding to the manual selection by the user is applied to the printing apparatus 101. Additionally, with the estimation processing being performed again, it is possible to properly estimate the newly attached printing medium.

As described above, according to the present embodiment, it is possible to estimate the type of the printing medium with a high degree of accuracy. That is, in the present embodiment, it is possible to suppress the complication of the learned model and to easily estimate the printing medium by limiting the printing media as the estimation target to a predetermined range of the number of the printing media. Additionally, it is possible to reduce the information amount to be learned and to reduce the capacity of the learned model.

### Other Embodiments

The embodiments described above are examples of executing the present disclosure and are not intended to limit the present disclosure. For example, the present disclosure may be applied not only to the printing apparatus that forms an image by ejecting ink on a sheet but also to a scanner that reads an image on a sheet or a post-processing device that processes a sheet.

The estimation of the sheet type may be executed not only by the CPU 301 mounted on the printing apparatus 101 but also executed by a scanner, a post-processing device, a PC, or the like.

The detailed classification (the second estimation) described in S507 and S508 is not limited to be two processes as long as it is at least one or more processes. For example, in a case where the types of the sheet S that are likely to be misestimated by the rough classification (the first estimation) in S504 are divided into five groups, five detailed classifications corresponding to the groups may be provided. Additionally, the number of the types of the printing medium in the detailed classifications corresponding to each group is not limited to two as long as it is two or more. For example, in a case where there are three types of the sheet S that are likely to be misestimated by the rough classification and the three types can be estimated accurately by the detailed classification, the three types may be classified as one group by the rough classification.

The machine learning apparatus 170 may be mounted on the printing apparatus 101. Additionally, the printing apparatus 101 may generate the learned model. The training data used in a case of generating the learned model may be saved in the memory 305.

The number of the above-described feature amounts is not limited to six, and a color, a thickness, or the like of the sheet S may be used. Additionally, although the type of the sheet S is estimated from the six feature amounts is described in the above-described embodiment, it is not limited thereto. For example, the type of the sheet S may be estimated from at least one of the feature amounts related to the surface information of the sheet S and at least one of the feature amounts related to the cross-section information of the sheet S. Moreover, the data obtained by the media sensor 206 and the like may be directly used as the input data without deriving the feature amounts. The output data of the training data is not limited to the type of the sheet, and a model name of the sheet, a sheet name determined by the user, or the like may be used.

The learned model may be recorded outside the printing apparatus 101. For example, the learned model may be recorded in a PC and the like connected via the input and output IF 303 and the USB port 304 of the printing apparatus 101. Additionally, the learned model is not limited to the DNN and may be a decision tree and the like. Moreover, although an example in which the learned model is applied to the rough classification and the detailed classification in the estimation of the type of the sheet S is described in the above-described embodiment, it is not limited thereto. For example, the learned model may be applied to either of the rough classification and the detailed classification. Specifically, the type of the sheet S may be estimated by applying the learned model to the rough classification and deriving the output value y by the detailed classification. That is, the type of the sheet S may be estimated by a combination of the learned model and the output value y.

Although a mode in which the learned model for the rough classification and the learned model for the detailed classification are used is described in the above-described embodiment, it is not limited to such an example. As long as the printing medium as the estimation target is determined such that the number of the printing media is within a predetermined range in a case of changing the type of the printing medium as the estimation target, any mode may be applied. Additionally, the learned model may be updated so as to be able to estimate the printing medium determined as described above. For example, as a result of changing the printing medium as the estimation target in a state of an operation using the learned model for the rough classification and the learned model for the detailed classification, the learned model for the detailed classification does not have to be used in some cases. That is, it is possible to uniquely estimate the type of the printing medium only with the learned model for the rough classification in some cases. On the other hand, as a result of changing the printing medium as the estimation target in a state in which the type of the printing medium can be uniquely estimated with only the learned model for the rough classification, the learned model for the detailed classification is necessary in some cases. Alternatively, as a result of changing the printing medium as the estimation target in a state in which the type of the printing medium can be uniquely estimated only with the learned model for the rough classification, there may be a case where the type of the printing medium can be uniquely estimated with only the learned model for the rough classification ultimately. Thus, the above-described embodiment is applicable to the learned model also in a mode in which the learned model for the rough classification, that is, a single learned model is used. Additionally, also in a mode in which the single learned model is used, as described above, it is possible to estimate the printing medium with a high degree of accuracy by learning the learned model so as to estimate the type of the printing medium within a predetermined range of the number.

Additionally, in the above-described embodiment, an example in which the training data is created in S509 and the training data is saved in S510 is described in the description of FIG. 5. Moreover, an example in which the training data corresponding to each printing medium is saved in advance is also described in the description of FIGS. 17A and 17B. In order to improve the learning accuracy, as described in the embodiment, although it is preferred to create the training data in S509 and save the training data in S510, the learned model may be updated by using the training data saved in advance. That is, a mode in which S509 and S510 are not executed may be adopted.

Furthermore, although an example in which both the manual selection and automatic selection may be performed in a case of changing the printing medium as the estimation target is described in the above-described embodiment, it is not limited to this example. A mode in which only either one of the manual selection and the automatic selection is performed may be applied.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-062611, filed Apr. 9, 2024, which is hereby incorporated by reference herein in its entirety.

What is claimed is:

1. An information processing apparatus, comprising:
an obtainment unit configured to obtain a characteristic value of a fed printing medium;
a registration unit configured to register a type of the printing medium as an estimation target;
an estimation unit configured to estimate a type of the fed printing medium by using an estimator from a plurality of types of the printing medium registered with the registration unit based on the characteristic value obtained by the obtainment unit;
a change unit configured to change the type of the printing medium registered with the registration unit; and
an output unit configured to output an instruction to update the estimator by using the characteristic value corresponding to the changed type of the printing medium.

2. The information processing apparatus according to claim 1, wherein
the change unit performs first change processing to change the type of the printing medium based on an operation by a user.

3. The information processing apparatus according to claim 2, wherein
the change unit is configured to accept an instruction to change the type of the printing medium by a group unit comprehending a plurality of types of the printing medium in the first change processing.

4. The information processing apparatus according to claim 2, wherein
the change unit is configured to accept an instruction to individually change each type of the printing medium in the first change processing.

5. The information processing apparatus according to claim 1, wherein
based on a usage history of the printing medium in the information processing apparatus, the change unit performs second change processing to change the type of the printing medium.

6. The information processing apparatus according to claim 5, wherein
in the second change processing, based on a usage history by a group unit comprehending a plurality of types of the printing medium, the change unit changes the types of the printing medium by the group unit.

7. The information processing apparatus according to claim 5, wherein
in the second change processing, based on a usage history of each type of the printing medium, the change unit individually changes each type of the printing medium.

8. The information processing apparatus according to claim 1, wherein
the change unit changes the type of the printing medium such that the number of the types of the printing medium is included in the number within a predetermined range.

9. The information processing apparatus according to claim 1, wherein
the estimator is a learned model that is learned based on training data including input data corresponding to the characteristic value and output data indicating the type of the printing medium corresponding to the input data.

10. The information processing apparatus according to claim 9, wherein
the output unit outputs an instruction to update the learned model by using the training data each corresponding to the type of the printing medium changed by the change unit.

11. The information processing apparatus according to claim 9, wherein
the training data includes the characteristic value obtained by the obtainment unit used in the estimation unit and an estimation result by the estimation unit.

12. The information processing apparatus according to claim 1, wherein
the obtainment unit obtains a feature amount related to surface information of the fed printing medium and a feature amount related to cross-section information of the fed printing medium and obtains the characteristic value based on the obtained feature amount.

13. The information processing apparatus according to claim 12, wherein
the obtainment unit obtains the feature amount related to the surface information from a sensor configured to obtain a surface image of the printing medium and obtains the feature amount related to the cross-section information of the printing medium from a sensor configured to obtain an electric signal of an ultrasonic wave transmitted through the printing medium.

14. The information processing apparatus according to claim 12, wherein
the surface information includes information related to at least one of luminance and irregularities of the fed printing medium.

15. The information processing apparatus according to claim 12, wherein
the cross-section information includes information related to at least one of a thickness and a basis weight of the fed printing medium.

16. The information processing apparatus according to claim 1, further comprising:
a display unit configured to display a result estimated by the estimation unit.

17. The information processing apparatus according to claim 1, wherein
the estimator is configured to estimate a printing medium group including a first printing medium and a second printing medium as one of the types of the printing medium, and
in a case where an estimation result by the estimator indicates the printing medium group, the estimation unit estimates the type of the fed printing medium by using a second estimator different from the estimator from the printing medium group including the first printing medium and the second printing medium based on the characteristic value obtained by the obtainment unit.

18. The information processing apparatus according to claim 17, wherein
the second estimator is a learned model that is learned by using training data corresponding to the types of the printing medium included in the printing medium group including the first printing medium and the second printing medium.

19. The information processing apparatus according to claim 17, wherein
in a case where the changed type of the printing medium includes the type of the printing medium included in the printing medium group, the output unit outputs an instruction to update the second estimator by using the characteristic value corresponding to the type of the printing medium included in the printing medium group.

20. A method of controlling an information processing apparatus, the method comprising:
obtaining a characteristic value of a fed printing medium;
estimating a type of the fed printing medium by using an estimator from a plurality of registered types of the printing medium based on the obtained characteristic value;
changing the registered type of the printing medium; and
outputting an instruction to update the estimator by using the characteristic value corresponding to the changed type of the printing medium.
